(19) United States
(12) Patent Application Publication
(10) Pub. No.: US 2026/0110925 A1
(43) Pub. Date: Apr. 23, 2026

(54) CONFIGURING LAYERS TO PROVIDE A STRAIN TO AN OPTICAL WAVEGUIDING STRUCTURE

(71) Applicant: Ciena Corporation, Hanover, MD (US)

(72) Inventors: Charles Baudot, Quebec (CA); Alexandre D. Simard, Quebec (CA); Elnaz Afsharipour, Quebec (CA)

(73) Assignee: Ciena Corporation, Hanover, MD (US)

(21) Appl. No.: 19/297,322

(22) Filed: Aug. 12, 2025

Related U.S. Application Data
(60) Provisional application No. 63/710,279, filed on Oct. 22, 2024.

(51) Int. Cl. G02F 1/025; G02F 1/015; G02F 1/35

(52) U.S. Cl. CPC G02F 1/025; G02F 1/0154; G02F 1/3511; G02F 2201/063; G02F 2202/105

(57) ABSTRACT

An apparatus comprises: a first layer of a first semiconductor material, wherein the first layer is substantially coplanar to a first plane, the first layer comprising first and second regions having p-type and n-type dopants mixed within the first semiconductor material, a third region adjacent to portions of the first and second regions, and an optical waveguiding structure configured to guide an optical wave, wherein a portion of the optical waveguiding structure is formed in the portion of the third region; a strain-inducing structure comprising one or more layers including a first strain-inducing layer comprising an alloy of silicon and germanium, where the first strain-inducing layer is configured to provide a strain to a portion of the first semiconductor material of the optical waveguiding structure; and a voltage source configured to apply a direct current electric field between the first and second regions.

### CROSS-REFERENCE TO RELATED APPLICATIONS

This application claims priority to and the benefit of U.S. Provisional Application Serial No. 63/710,279, entitled “CONFIGURING LAYERS TO PROVIDE A STRAIN TO AN OPTICAL WAVEGUIDING STRUCTURE,” filed October 22, 2024, the entire disclosure of which is incorporated herein by reference.

### TECHNICAL FIELD

This disclosure relates to configuring layers to provide a strain to an optical waveguiding structure.

### BACKGROUND

Compact designs coupled with advances in mass production capabilities and technologies have contributed to the widespread adoption of integrated circuit (IC) devices. Some IC platforms comprise structures configured to guide and manipulate optical waves. In some silicon photonic IC devices, signal modulation can be performed with the help of phase shifters which are configured as Mach-Zehnder interferometers. Some phase shifters are electro-optic devices which can induce a relative delay to the optical source using an electrical signal. In-phase coherent optical beams can interfere constructively and generate a relative “1” whereas out-of-phase beams can interfere destructively and thus generate a relative “0”.

### SUMMARY

In one aspect, in general, an apparatus comprises: a first layer of a first semiconductor material, wherein the first layer is substantially coplanar to a first plane, the first layer comprising a first region having p-type dopants mixed within the first semiconductor material, a second region having n-type dopants mixed within the first semiconductor material, a third region wherein at least a portion of the third region is adjacent to a portion of the first region and a portion of the second region, and an optical waveguiding structure configured to guide an optical wave having a propagation direction that is substantially parallel to the first plane, wherein at least a portion of the optical waveguiding structure is formed in the portion of the third region that is adjacent to the portion of the first region and the portion of the second region; a strain-inducing structure comprising one or more layers arranged along an axis that is substantially perpendicular to the first plane, the one or more layers comprising a first strain-inducing layer comprising an alloy of silicon and germanium, where the first strain-inducing layer is configured to provide a strain to at least a portion of the first semiconductor material of the optical waveguiding structure; and a voltage source configured to apply a direct current electric field between the first region and the second region.

Aspects can include one or more of the following features.

The first strain-inducing layer is adjacent to a portion of the third region that contains the optical waveguiding structure.

The first semiconductor material comprises silicon.

The first strain-inducing layer conducts at least a portion of the direct current electric field.

The one or more layers of the strain-inducing structure further comprise a second strain-inducing layer formed in proximity to the first strain-inducing layer, where the second strain-inducing layer is configured to provide a strain to at least a portion of the first semiconductor material of the optical waveguiding structure.

The second strain-inducing layer is formed on at least a portion of the first strain-inducing layer.

The second strain-inducing layer comprises silicon nitride.

The one or more layers of the strain-inducing structure further comprise at least one layer separating the first strain-inducing layer from the second strain-inducing layer.

The second strain-inducing layer comprises a first portion of a metal layer and a second portion of a metal layer.

A spacing layer is formed on at least a portion of the first strain-inducing layer and the second strain-inducing layer is formed on at least a portion of the spacing layer.

The second strain-inducing layer comprises silicon nitride and the spacing layer comprises silicon dioxide.

The first strain-inducing layer is configured to provide a strain to the at least a portion of the first semiconductor material that shifts a nonlinear optical property associated with the at least a portion of the first semiconductor material.

The nonlinear optical property is a direct current Kerr effect.

The first strain-inducing layer has a first width and a second width along respective axes that are substantially parallel to the first plane and substantially perpendicular to the propagation direction, the first width being closer to an end of the optical waveguiding structure than the second width and the first width being smaller than the second width.

The optical waveguiding structure comprises a rib waveguide and the first strain-inducing layer is formed over the rib waveguide.

An orientation of the direct current electric field relative to a crystal structure of the first semiconductor material is selected to provide an increased electro-optic effect in the third region.

The strain provided by the first strain-inducing layer is associated with a difference between a lattice parameter of the alloy of silicon and germanium of the first strain-inducing layer and a lattice parameter of the first semiconductor material.

A thickness of the first strain-inducing layer is configured to confine an optical power of an optical wave to the optical waveguiding structure.

The thickness of the first strain-inducing layer is configured to confine at least 80% of an optical power of an optical wave in the optical waveguiding structure.

In another aspect, in general, a method comprises: configuring a first layer of a first semiconductor material, wherein the first layer is substantially coplanar to a first plane, the first layer comprising a first region having p-type dopants mixed within the first semiconductor material, a second region having n-type dopants mixed within the first semiconductor material, a third region wherein at least a portion of the third region is adjacent to a portion of the first region and a portion of the second region, and an optical waveguiding structure configured to guide an optical wave having a propagation direction that is substantially parallel to the first plane, wherein at least a portion of the optical waveguiding structure is formed in the portion of the third region that is adjacent to the portion of the first region and the portion of the second region; arranging a strain-inducing structure in proximity to the optical waveguiding structure, the strain-inducing structure comprising one or more layers arranged along an axis that is substantially perpendicular to the first plane, where the one or more layers comprise a first strain-inducing layer comprising an alloy of silicon and germanium, where the first strain-inducing layer is configured to provide a strain to at least a portion of the first semiconductor material of the optical waveguiding structure; and configuring a voltage source to apply a direct current electric field between the first region and the second region.

Aspects can have one or more of the following advantages.

Some silicon devices comprising layers of other material, for instance silicon germanium or silicon nitride, can be utilized in a Mach-Zehnder configuration to fabricate an integrated high-speed and low-loss modulator for electro-optic communication. In some examples, modulation using nonlinear effects, such as the Kerr effect, can be difficult to achieve in materials such as pristine silicon. In some examples, a crystal asymmetry to a material, i.e., silicon, can be introduced by applying a high electric field. Without using the methods disclosed herein, the resulting asymmetric effect can be small. In contrast, using strain-inducing layers, i.e., compressive layers, can be associated with boosting the field effect and amplifying the crystal asymmetry to increase accessibility and applicability of silicon modulators. In other words, some of the methods disclosed herein can be utilized to induce a strain in an underlying crystal structure of a waveguide. In some examples, this strain can enhance electro-optical effects associated with the device.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1C are schematic diagrams of example devices.

FIGS. 2A-2C are schematic diagrams of portions of example devices.

FIGS. 3A-3B are schematic diagrams of front views of example devices.

FIG. 4 is a schematic diagram of an example device.

FIGS. 5A-5B are schematic diagrams of views of example devices.

FIG. 6 is a flowchart of an example method of configuring a device.

### DETAILED DESCRIPTION

Some photonic integrated circuits (PICs) can be implemented as a system comprising optical circuits integrated on one or more chips. In some examples, a system can be implemented in various configurations, including as a single apparatus or as a combination of one or more apparatuses that collectively perform the functions of a system. Some photonic integrated circuits (PICs) combine a plurality of optical components where each optical component is configured to perform a function.

Some photonic integrated circuits can comprise optical components formed by structures in one or more layers of material of a photonic integrated circuit. In some examples, the performance of an optical component can depend on factors such as structural properties, i.e., dimensions, layer thicknesses, etc., or characteristics of materials.

Some photonic integrated circuits can comprise thin layers of material, sometimes referred to as limited thickness layers. Some limited thickness layers can have a limited thickness that is substantially less than or equal to a maximum thickness. In some examples, a limited thickness layer can comprise a monolayer, i.e., a single layer of molecules or atoms of a material. Such implementations can be associated with maximum thicknesses of 50 nm. In some examples, configuring a limited thickness layer can be associated with operating characteristics of a photonic integrated circuit, as described later in more detail.

Some photonic integrated circuits can comprise optical components that are configured to provide a modulation to an optical wave, i.e., a modulator. In some examples, an optical component can be configured as a phase shifter that can provide a phase modulation, also referred to as a phase delay or a phase shift, to an optical wave. Some phase shifters can be configured as a junction or diode. In some examples, these junctions can be configured as PIN junctions comprising an undoped intrinsic semiconductor region between a p-type semiconductor region and an n-type semiconductor region. In some examples, a p-type semiconductor region and an n-type semiconductor region can comprise a semiconductor material having dopants, i.e., p-type dopants or n-type dopants, mixed within. Using the plasma density effect, phase changes can be applied to the optical source because changes in electrical carrier density can generate a change in waveguide refractive index and thus a phase shift. However, free carriers can also partially absorb the optical source. Thus, a device can be a subtle compromise between efficiency and signal attenuation.

Some modulators can utilize alternative electro-optic (EO) effects, such as nonlinear effects. In some examples, generating these EO effects in materials such as silicon (Si) can be challenging due to material properties. For instance, Si is a centrosymmetric crystal and thus can lack electrical-field related induced optical perturbations, i.e., nonlinear effects. In some implementations, a refractive index associated with a material can change in response to an applied electric field. This change can be referred to as the Kerr effect. In some examples, the Kerr effect can be obtained in Si by applying a very strong electric field to a waveguide. For instance, a direct current (DC) field can be applied to a waveguide to generate a DC Kerr effect. The applied electric field can generate a mechanical stress on the waveguide and trigger crystal asymmetry. Without using the methods disclosed herein, in some implementations, the EO effect in silicon can be low. Moreover, an electric field generated using a PIN diode configuration can be limited in applied bias because of the intrinsic junction breakdown voltage. In contrast, using the methods disclosed herein, Kerr effects in Si phase shifters or modulators can be enhanced.

As used herein, the term DC electric field refers to an electric field that is relatively constant for a period of time or has a relatively low frequency over a period of time (e.g., a frequency below 1 MHz, or below 1 kHz). In other words, a DC electric field is substantially time-invariant.

In some implementations, growing a layer of silicon-germanium (SiGe), i.e., an alloy of silicon and germanium, atop a semiconductor material such as Si can introduce a strain, sometimes referred to as a stress. This strain can occur because of a lattice mismatch between Si and SiGe. In other words, the strain provided by a strain-inducing layer is associated with a difference between a lattice parameter of a material of the strain-inducing layer, i.e., SiGe, and a lattice parameter of a semiconductor material, i.e., Si. In some examples, this lattice mismatch can be around 4%. Growing a SiGe layer on top of Si can thus induce a crystal lattice deformation in the latter. In some examples, the strain can be used to modify the charge mobility and can boost a performance, i.e., an electronic performance, associated with a device.

In some examples, Ge concentration of an alloy of Si and Ge can impact device performance because Ge can absorb light in telecommunication bandwidths at high concentrations. In some examples, optical absorption by an alloy of Si and Ge can be low for Ge concentrations below 50%. In some implementations, a mono-crystalline epitaxial layer of SiGe without defects can be grown on top of a waveguide. Some defects can relax the induced stress and can also generate optical losses. Some SiGe layers can comprise Ge concentrations of 5% to 30%. In some examples, a SiGe concentration above 30% can induce a strain so high that defects start to be generated in the epitaxial layer.

Some IC devices can comprise an epitaxial layer of SiGe grown on a waveguide to introduce a crystal asymmetry in the underlying Si such that the Kerr effect in the underlying Si waveguide can be increased. In other words, a layer can provide a strain that shifts a nonlinear optical property, a DC Kerr effect, of a material of another layer. In some examples, if the upper section of the waveguide is strained, a crystal asymmetry can be distributed progressively through the underlying Si and can generate a vertically asymmetric waveguide. Some surface SiGe layers can lower an access electrical resistance of a phase shifter.

In some implementations, configuring layers of a device can balance fabrication and operational considerations with properties of materials of the layers. Some devices can comprise one or more layers having a limited thickness that is less than or equal to a maximum thickness.

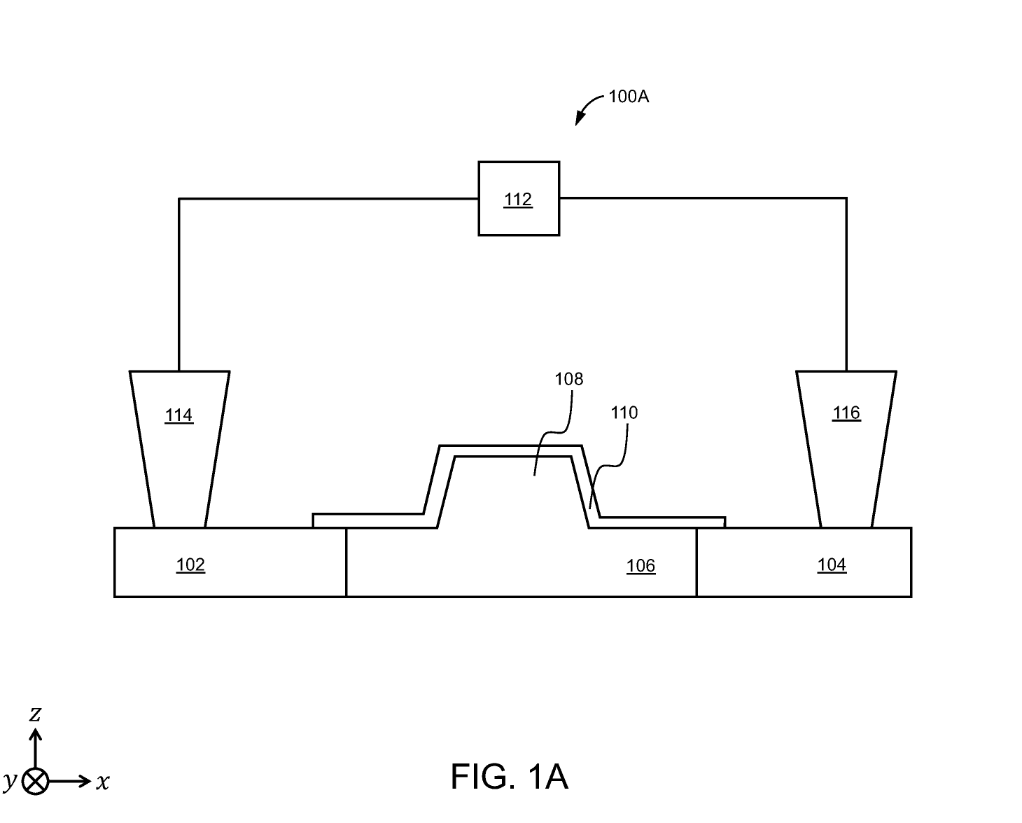

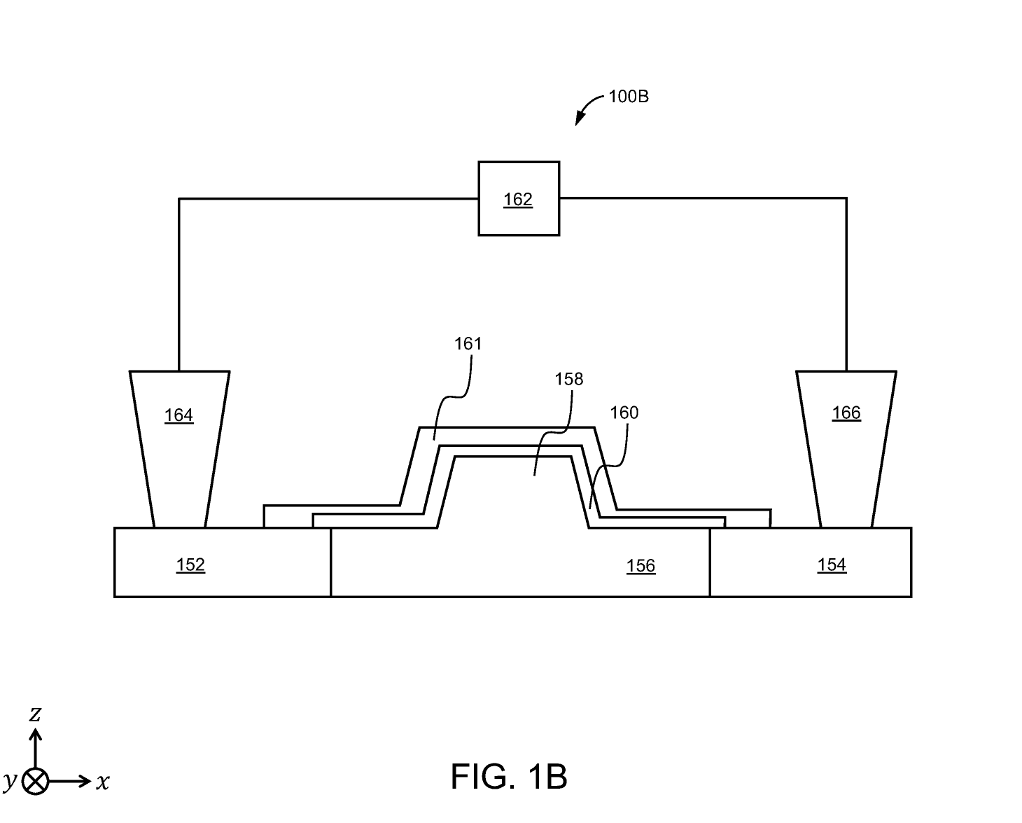

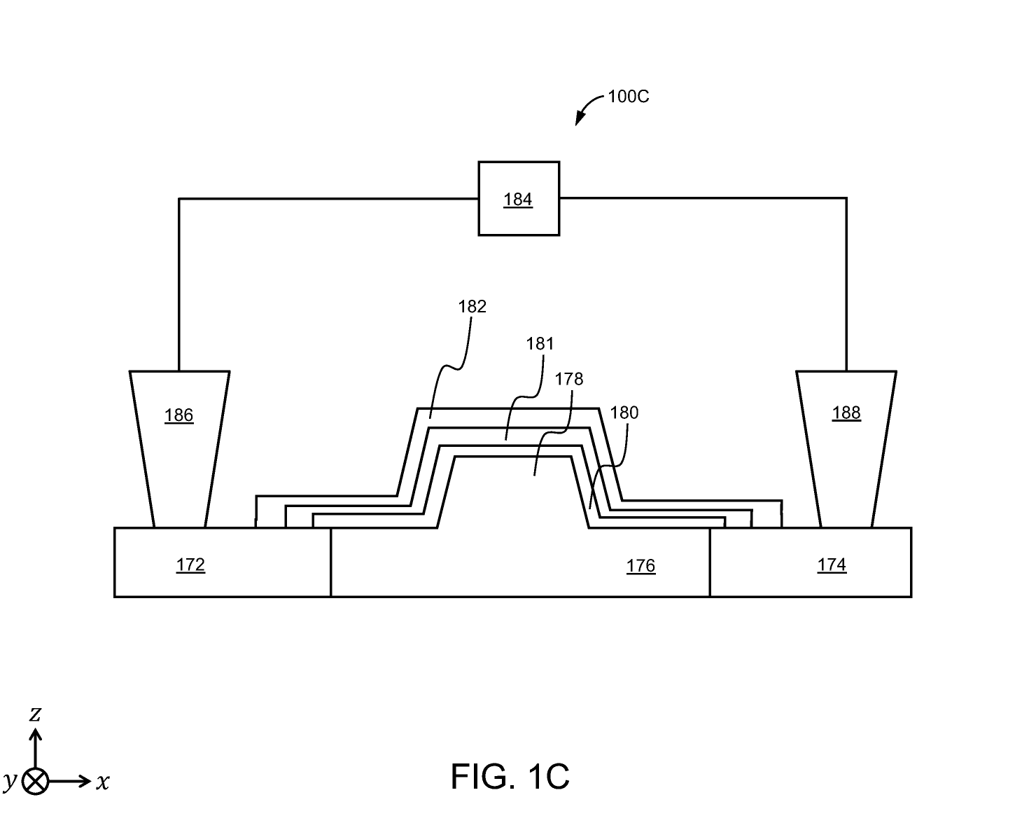

FIG. 1A depicts a front view of an example device 100A, i.e., an IC device. By way of example, a coordinate system comprising axes also depicted. The device 100A comprises a first layer of a first semiconductor material, wherein the first layer is substantially coplanar to a first plane, i.e., a plane that is parallel to the xy-plane. The first layer comprises a first region 102 having p-type dopants mixed within the first semiconductor material, a second region 104 having n-type dopants mixed within the first semiconductor material, and a third region 106 wherein at least a portion of the third region is adjacent to a portion of the first region 102 and a portion of the second region 104. The first layer also comprises an optical waveguiding structure 108, sometimes referred to as an optical waveguide, configured to guide an optical wave having a propagation direction that is substantially parallel to the first plane. At least a portion of the optical waveguiding structure 108 is formed in the portion of the third region 106 that is adjacent to the portion of the first region 102 and the portion of the second region 104. The device 100A further comprises a second layer 110 of a second semiconductor material formed over at least a portion of the third region 106 that contains the optical waveguiding structure 108. The second layer 110 of the second semiconductor material is configured to provide a strain to at least a portion of the first semiconductor material of the optical waveguiding structure 108. A voltage source 112 is configured to apply an electric field that is substantially time-invariant, i.e., a direct current (DC) electric field, between the first region 102 and the second region 104. In this example, an electrode 114 and an electrode 116 are configured to apply a DC current from the voltage source 112 to the first region 102 and the second region 104, respectively. In some examples, the first semiconductor material can comprise silicon and the second semiconductor material can comprise an alloy of silicon and germanium.

In other words, the device 100A comprises a strain-inducing structure comprising one or more layers arranged along an axis, i.e., the z-axis, that is substantially perpendicular to the first plane. At least one layer of the one or more layers of the strain-inducing structure, i.e., the second layer 110, is configured to provide a strain to at least a portion of the first semiconductor of the optical waveguiding structure 108. At least one layer of the one or more layers of the strain-inducing structure, i.e., the second layer 110, has a limited thickness that is substantially less than or equal to a maximum thickness.

In some examples, an optical waveguiding structure can be configured in a rib geometry. For instance, the optical waveguiding structure 108 is configured as a rib waveguide, i.e., having a trapezoidal or rectangular cross-section. In some examples, configuring a strain-inducing layer on the upper corners of an optical waveguiding structure can be associated with a higher strain induced on a material of the optical waveguiding structure.

As previously described, some layers configured to provide a strain can comprise an alloy of silicon and germanium. In some implementations, an advantage associated with using SiGe compared to other materials can be that the refractive index of SiGe can be slightly higher than pure Si. Thus, the SiGe layer can shift the optical mode further up in the rib section, in a region where the Kerr effect can be more efficient. In other words, a strain-inducing layer can be configured to provide a strain in a region of an optical waveguiding structure and confine an optical mode in that region of the optical waveguiding structure.

In some implementations, configuring strain-inducing layers atop an optical waveguiding structure can balance optical mode confinement in the optical waveguiding structure. Factors such as a thickness or refractive index of a strain-inducing layer can influence an optical power associated with an optical wave propagating in the optical waveguiding structure By way of example, increasing a thickness of a layer comprising a material having a high refractive index can result in an optical mode shifting away from the core of the optical waveguiding structure and into the surrounding higher-index region. Such implementations can be associated with reduced optical powers confined in the optical waveguiding structure and decreased modulation efficiency of the optical waveguiding structure. In contrast, limiting a thickness of the layer can allow for an optical wave to remain confined in the optical waveguiding structure. In other words, a thickness of a strain-inducing layer comprising SiGe can be limited to a maximum thickness to allow for an optical power of an optical wave to be confined to an optical waveguiding structure. In some examples, the maximum thickness can allow for greater than 50% of an optical power of an optical wave to be confined to an optical waveguiding structure. In some examples, the maximum thickness can allow for greater than 80% of an optical power of an optical wave to be confined to an optical waveguiding structure.

Another advantage associated with using a material such as SiGe as a strain-inducing layer is that germanium is in the same group of the periodic table of elements as silicon. Thus, the addition of germanium to silicon can not change the material type.

In some implementations, using a material such as SiGe as a strain-inducing layer can be associated with other advantages. In some examples, a layer comprising SiGe, or SiGe having dopants mixed within, can be conductive such that the layer can participate in device biasing when an electric field, i.e., a direct current bias, is applied to a device. In some implementations, configuring a device with a conductive layer can lower an access resistance of the device. In some examples, an electric field can be concentrated in a layer comprising SiGe, which can amplify an effect of the electric field, i.e., shifting a nonlinear optical property. In some implementations, a conductivity of a layer comprising silicon and germanium can be adjusted by varying a ratio of silicon and germanium.

In some examples, strained layers of a dielectric material, i.e., silicon nitride (SiN) formed in proximity to Si can also transfer mechanical strain to Si. In some implementations, a strained SiN layer can be formed in proximity to a rib waveguide section to increase the Kerr effect. In some examples, the use of SiGe and/or SiN can compress the upper section of a Si phase shifter and generate an asymmetry.

Including SiN layers in a system can be associated with fabrication considerations. In some examples, growing SiN layers on structures formed from silicon, i.e., optical waveguiding structures, can be difficult. Deposition methods can allow for a layer of SiN to be formed in proximity to an optical waveguiding structure such that other layers can transfer mechanical strain to the optical waveguiding structure. An advantage associated with using SiGe as a strain-inducing layer is that a SiGe layer can be grown on a structure formed from silicon. Layers of SiN can then be deposited in proximity to an optical waveguiding structure such that the SiGe layer provides an interface between the optical waveguiding structure and SiN. In other words, in some examples, a layer of SiGe and a layer of SiN can be formed in proximity to an optical waveguide. This configuration can be associated with other advantages. For instance, a SiN layer can protect the SiGe layer from contamination during subsequent fabrication processes.

FIG. 1B depicts a front view of an example device 100B, i.e., an IC device. The device 100B comprises a first layer of a first semiconductor material. The first layer comprises a first region 152 comprising p-type dopants mixed within the first semiconductor material, a second region 154 comprising n-type dopants mixed within the first semiconductor material, and a third region 156 that is adjacent to a portion of the first region 152 and a portion of the second region 154. An optical waveguiding structure 158 configured to guide an optical wave having a propagation direction that is substantially parallel to the first plane is formed in the third region 156. The device 100B further comprises a second layer 160 of a second material formed over the optical waveguiding structure 158. A third layer 161 of a third material is formed over the second layer 160. One or both of the second layer 160 and the third layer 161 can be configured to provide a strain to the first semiconductor material of the optical waveguiding structure 158. The second layer 160 can be formed from a material that enables the third layer 161 to adhere to the second layer 160 more strongly than the third layer 161 would adhere to the third region 156 of the first layer. A voltage source 162 is configured to apply a direct current (DC) electric field between the first region 152 and the second region 154. An electrode 164 and an electrode 166 are configured to apply a DC current from the voltage source 162 to the first region 152 and the second region 154, respectively. In some examples, the first semiconductor material can comprise silicon, the second material can comprise an alloy of silicon and germanium or silicon dioxide, and the third material can comprise silicon nitride.

In other words, the device 100B comprises a strain-inducing structure comprising one or more layers arranged along an axis, i.e., the z-axis, that is substantially perpendicular to the first plane. At least one layer of the one or more layers of the strain-inducing structure, i.e., the second layer 160 and the third layer 161, is configured to provide a strain to at least a portion of the first semiconductor of the optical waveguiding structure 108. At least one layer of the one or more layers of the strain-inducing structure, i.e., the second layer 160, has a limited thickness that is substantially less than or equal to a maximum thickness.

In some examples, a layer of material can allow for other layers of material to adhere, or stick, to other layers. FIG. 1C depicts a front view of an example device 100C. The device 100C comprises a first layer of a first semiconductor material. The first layer comprises a first region 172 comprising p-type dopants mixed within the first semiconductor material, a second region 174 comprising n-type dopants mixed within the first semiconductor material, and a third region 176 that is adjacent to a portion of the first region 172 and a portion of the second region 174. An optical waveguiding structure 178 configured to guide an optical wave having a propagation direction that is substantially parallel to the first plane is formed in the third region 176. The device 100C further comprises a second layer 180 of a second semiconductor material formed over a portion of the optical waveguiding structure 178. A third layer 181 is formed over at least a portion of the second layer 180. A fourth layer 182 is formed over at least a portion of the third layer 181. A voltage source 184 is configured to apply an electric field that is substantially time-invariant, i.e., a direct current (DC) electric field, between the first region 172 and the second region 174 by an electrode 186 and an electrode 188.

The second layer 180, i.e., a first strain-inducing layer, is configured to provide a strain to the first semiconductor material of the optical waveguiding structure 178. The fourth layer 182, i.e., a second strain-inducing layer, is configured to provide a strain to the first semiconductor material of the optical waveguiding structure 178. In other words, the device 100C comprises a second strain-inducing layer formed in proximity to the first strain-inducing layer. In some implementations, the third layer 181 can be configured as a limited thickness layer. In some implementations, the second layer 180 can comprise a material such as SiGe, the third layer 181 can comprise a material such as silicon dioxide (SiO₂), and the fourth layer 182 can comprise a material such as SiN. In other words, the third layer 181 is a spacing layer between the second layer 180 and the fourth layer 182. In some examples, including a silicon dioxide layer in a device can allow for a layer of SiN to adhere to the device.

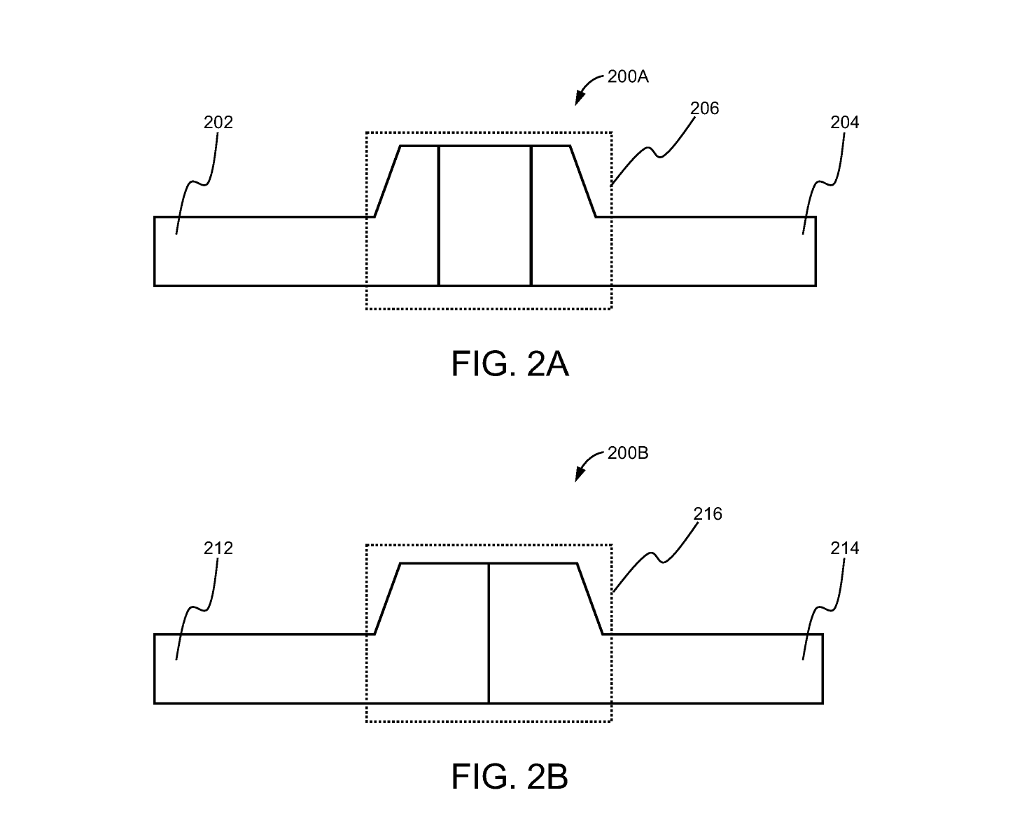

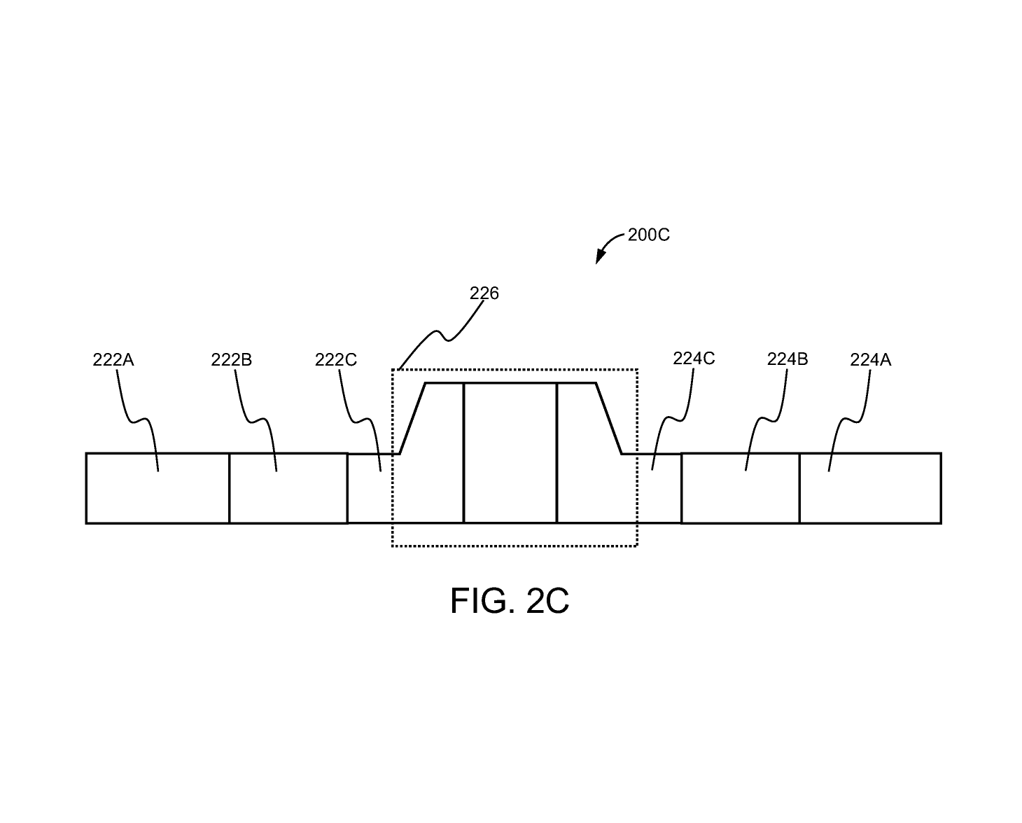

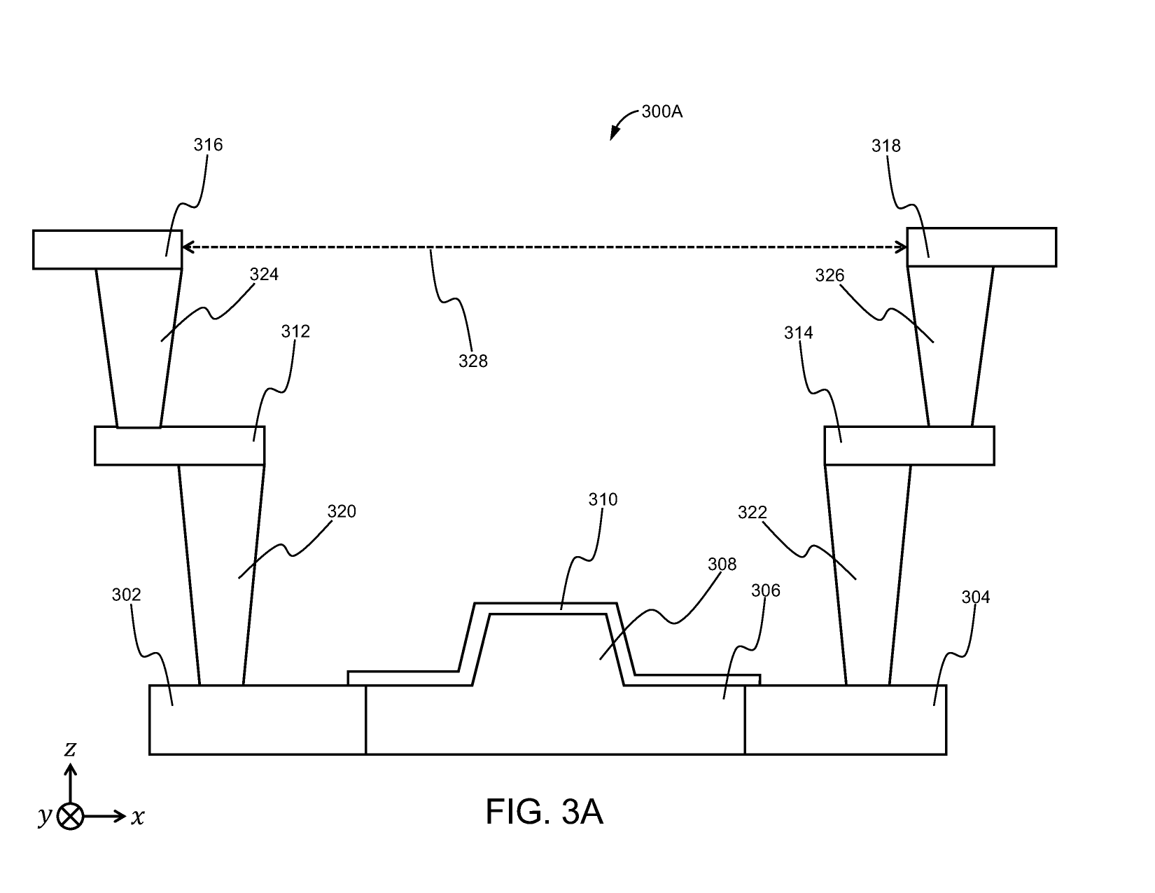

In some implementations, an optical waveguiding structure can also include a portion of each of the first region and the second region. FIGS. 2A-2B depict example portions 200A-200B of IC devices. The portion 200A comprises a first region 202 having dopants mixed within and a second region 204 having dopants mixed within. An optical waveguiding structure 206 is formed in a region between the first region 202 and the second region 204 and comprising portions of doped material. The portion 200B comprises a first region 212 having dopants mixed within and a second region 214 having dopants mixed within. An optical waveguide 216 is formed in a region between the first region 212 and the second region 214 and comprising portions of doped material.

In some implementations, portions of a first region and portions of a second region can comprise dopants with varying concentrations. FIG. 2C depicts a portion 200C of a device. The portion 200C comprises a first region having dopants mixed within, i.e., n-type dopants. The first region comprises a portion 222A comprising a concentration of dopants, a portion 222B comprising a concentration of dopants, and a portion 222C comprising a concentration of dopants. In some examples, the portion 222A can have a higher concentration of dopants than the portion 222B and the portion 222C, while the portion 222B can have a higher concentration of dopants than the portion 222C. The portion 200C comprises a second region having dopants mixed within, i.e., p-type dopants. The second region comprises a portion 224A comprising a concentration of dopants, a portion 224B comprising a concentration of dopants, and a portion 224C comprising a concentration of dopants. In some examples, the portion 224A can have a higher concentration of dopants than the portion 224B and the portion 224C, while the portion 224B can have a higher concentration of dopants than the portion 224C. The portion 200C further comprises an optical waveguiding device 226 comprising portions of doped material formed between the first region and the second region.

In some implementations, a device can comprise multiple chips or substrates, where each chip or substrate comprises portions of electronic circuitry or optical elements. For instance, in some examples, electronic control circuitry can be formed on one chip while optical waveguiding structures can be formed on another chip. Some chips can be arranged in a flip-chip configuration to allow for three-dimensional integration of multiple chips or substrates. Some flip-chip configurations comprise conductive structure such as wire bonds, microbumps, vias, or layers comprising metal to facilitate electrical communication between multiple layers or chips. In some implementations, metal layers, or portions thereof, can be configured to provide a strain to an optical waveguide.

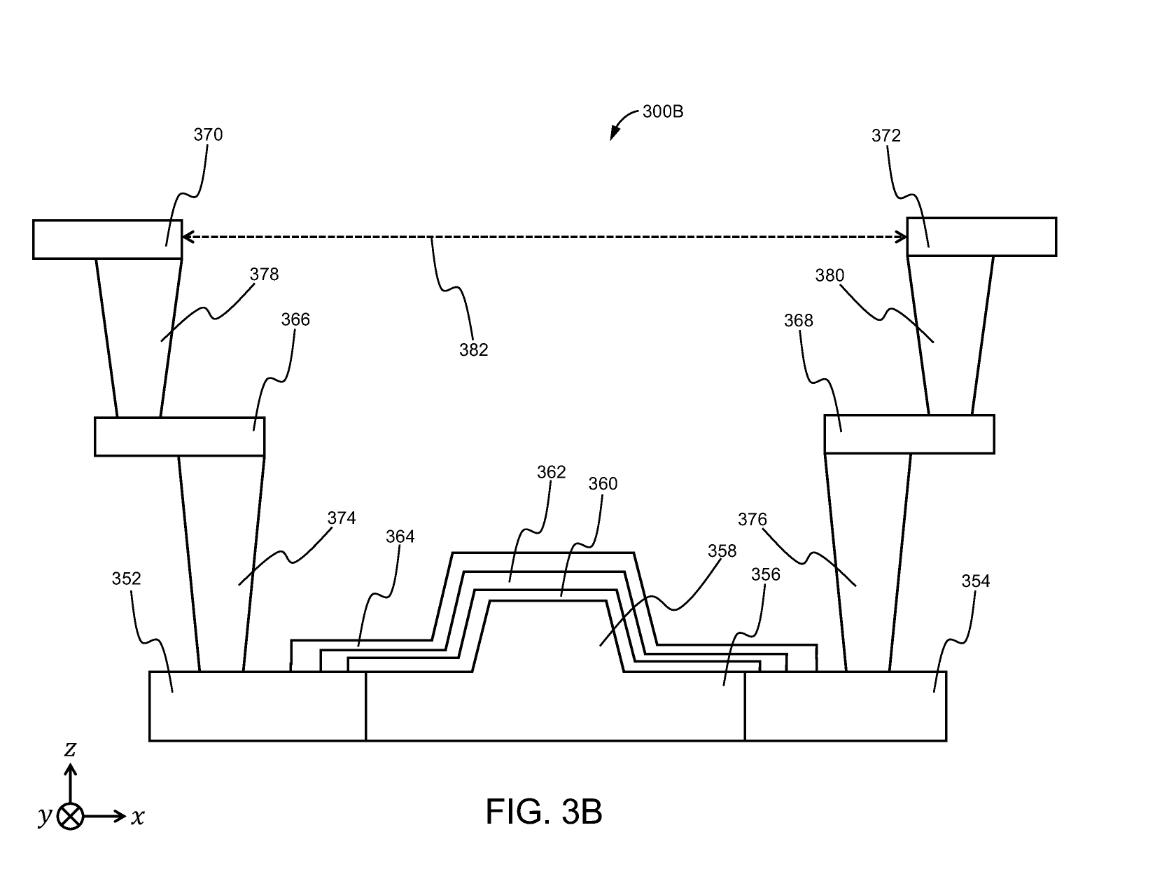

FIG. 3A depicts a front view of a device 300A. The device 300A comprises a layer of a semiconductor material comprising a first region 302 having dopants mixed within, a second region 304 having dopants mixed within, and a third region 306 between the first region 302 and the second region 304. An optical waveguide 308 is formed from a portion of the third region 306. The device 300A further comprises a first strain-inducing layer 310, i.e., of a strain-inducing structure, formed over the optical waveguide 308, where the first strain-inducing layer 310 is configured to provide a strain to a material of the optical waveguide 308. The device 300A further comprises a portion 312 of a metal layer, a portion 314 of a metal layer, a portion 316 of a metal layer, and a portion 318 of metal layer. In some examples, the portion 312 and the portion 314 can be portions of a first metal layer while the portion 316 and the portion 318 can be portions of a second metal layer. The portion 312 of the metal layer is in electrical communication with the first region 302 via a conductive structure 320, i.e., a metal via. The portion 314 of the metal layer is in electrical communication with the second region 304 via a conductive structure 322, i.e., a metal via. The portion 316 is in electrical communication with the portion 312 by a conductive structure 324, i.e., a metal via, and the portion 318 is in electrical communication with the portion 314 by a conductive structure 326, i.e., a metal via. In some examples, a voltage source (not shown) can be configured to apply an electric field between the first region 302 and the second region 304 using the portion 312, the portion 314, the portion 316, the portion 318, the conductive structure 320, the conductive structure 322, the conductive structure 324, and the conductive structure 326. In some examples, the portion 316 and the portion 318 can apply a strain to a material of the optical waveguide 308. By way of example, as shown in FIG. 3A, the portion 316 and the portion 318 are separated by a separation distance 328. In some examples, varying a separation distance 328 between the portions of a metal layer can induce a strain on a material of the optical waveguide 308. In other words, the device 300A comprises a second strain-inducing layer i.e., of a strain-inducing structure, that is configured to provide a strain to at least a portion of a material of the optical waveguide 308. As shown in FIG. 3A, the second strain-inducing layer, i.e., the portion 316 and the portion 318, are formed in proximity to the first strain-inducing layer 310. In some implementations, layers of material, i.e., the portion 312 and the portion 314, can be formed between the first strain-inducing layer 310 and the second strain-inducing layer. i.e., the portion 316 and the portion 318.

In some examples, the separation distance 328 can depend other factors, such as a separation distance between the portion 312 and the portion 314 and a geometry of the optical waveguide 308. As previously described, the portion 312 and the portion 314 can be part of a layer while the portion 316 and the portion 318 can be part of a layer. In some examples, these layers can be configured to guide radiofrequency (RF) waves, i.e., as a waveguide. In some implementations, a velocity of a radiofrequency (RF) wave propagating through these layers can be matched with a velocity of an optical wave propagating through the optical waveguide 308.

FIG. 3B depicts an example device 300B comprises a layer of a semiconductor material comprising a first region 352 having dopants mixed within, a second region 354 having dopants mixed within, and a third region 356 between the first region 352 and the second region 354. An optical waveguide 358 is formed from a portion of the third region 356. The device 300B further comprises a first strain-inducing layer 360 formed over the optical waveguide 358, where the first strain-inducing layer 360 is configured to provide a strain to a material of the optical waveguide 358. The device 300B further comprises a limited-thickness layer 362, i.e., a layer of silicon dioxide, and a second strain-inducing layer 364, i.e., a layer of silicon nitride. The device 300B further comprises a portion 366 of a metal layer, a portion 368 of a metal layer, a portion 370 of a metal layer, and a portion 372 of a metal layer. In some examples, the portion 366 and the portion 368 can be portions of a first metal layer while the portion 370 and the portion 372 can be portions of a second metal layer. The portion 366 of the metal layer is in electrical communication with the first region 352 via a conductive structure 374, i.e., a metal via. The portion 368 of the metal layer is in electrical communication with the second region 354 via a conductive structure 376, i.e., a metal via. The portion 370 is in electrical communication with the portion 366 via a conductive structure 378 and the portion 372 in in electrical communication with the portion 368 via a conductive structure 380. In some examples, a voltage source (not shown) can be configured to apply an electric field between the first region 352 and the second region 354 using the portion 366, the portion 368, the portion 370, the portion 372, the conductive structure 374, the conductive structure 376, the conductive structure 378, and the conductive structure 380. In some examples, the portion 370 and the portion 372 can apply a strain to a material of the optical waveguide 358. By way of example, as shown in FIG. 3B, the portion 370 and the portion 372 are separated by a separation distance 382. In some examples, varying a separation distance 382 between the portions of a metal layer can induce a strain on a material of the optical waveguide 358. In this example, the device 300B comprises a strain-inducing structure comprising the first strain-inducing layer 360, the second strain-inducing layer 364, and a third strain-inducing layer, i.e., a metal layer comprising the portion 370 and the portion 372.

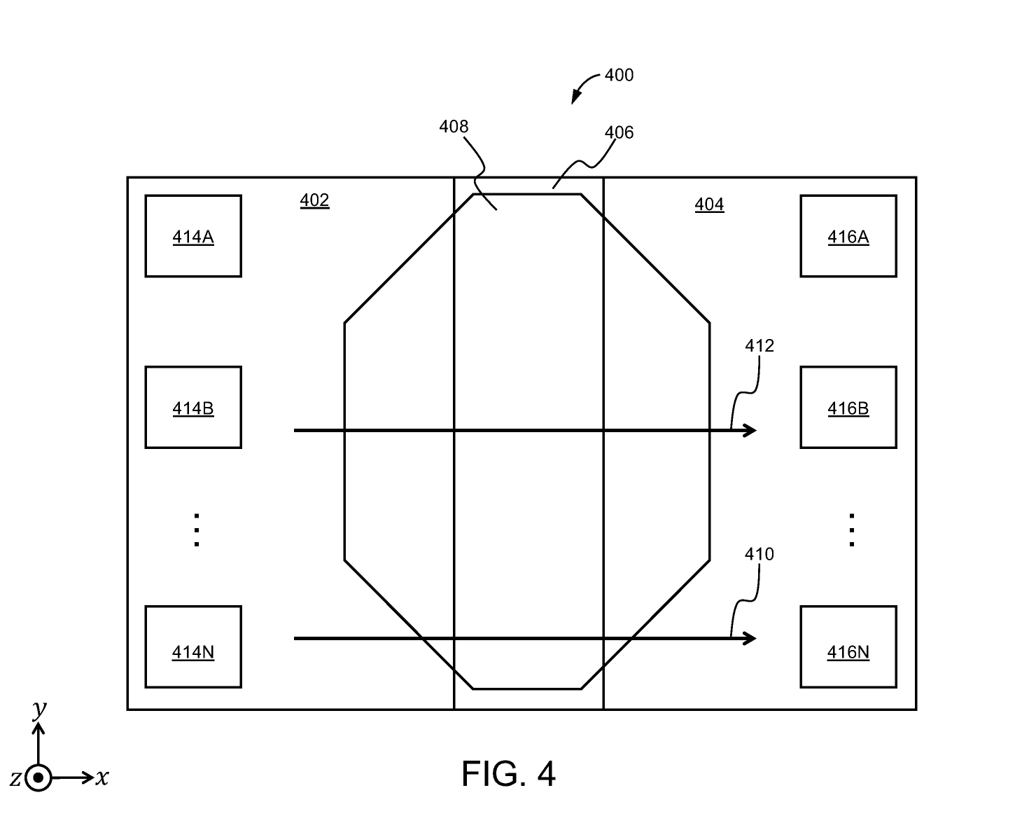

In some examples, the added layers can change an optical mode configuration associated with an optical wave propagating through a waveguiding structure because of the change in refractive index of the added layers. In some examples, a tapering section can be included at the optical inputs and optical outputs to allow a smooth transition in waveguide architecture. FIG. 4 depicts a top view of an example device 400. The device 400 comprises a first layer that is coplanar with a first plane, in this example the xy plane. The first layer comprises a first region 402 and a second region 404. Between the first region 402 and the second region 404 is a region comprising an optical waveguiding structure 206 associated with a propagation direction, in this example, the propagation direction is the y-axis. A layer 408 of a second semiconductor material is formed over the optical waveguiding structure 406. The layer 408 has a first width and a second width along an axis 410 and an axis 412, respectively, that are substantially parallel to the first plane and substantially perpendicular to the propagation direction. The first width is closer to an end of the optical waveguiding structure 406 than the second width and the first width is smaller than the second width. The first region 402 comprises a plurality of metal contacts 414A-414N, i.e., a metal contact 414A, a metal contact 414B, and a metal contact 414N. In some implementations, the plurality of metal contacts 414A-414N can be referred to as portions of a metal layer. The second region 404 comprises a plurality of metal contacts 416A-416N, i.e., a metal contact 416A, a metal contact 416B, and a metal contact 416N. The plurality of metal contacts 414A-414N and the plurality of metal contacts 416A-416N can be used to apply a bias between the first region 402 and the second region 404.

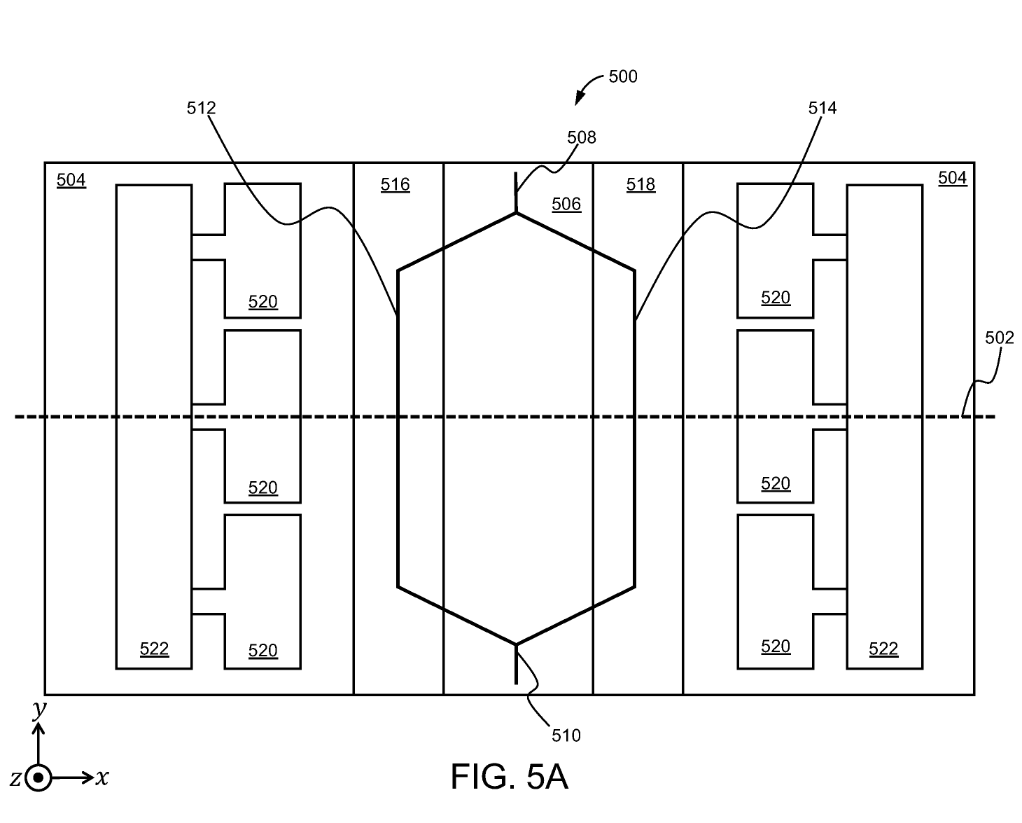

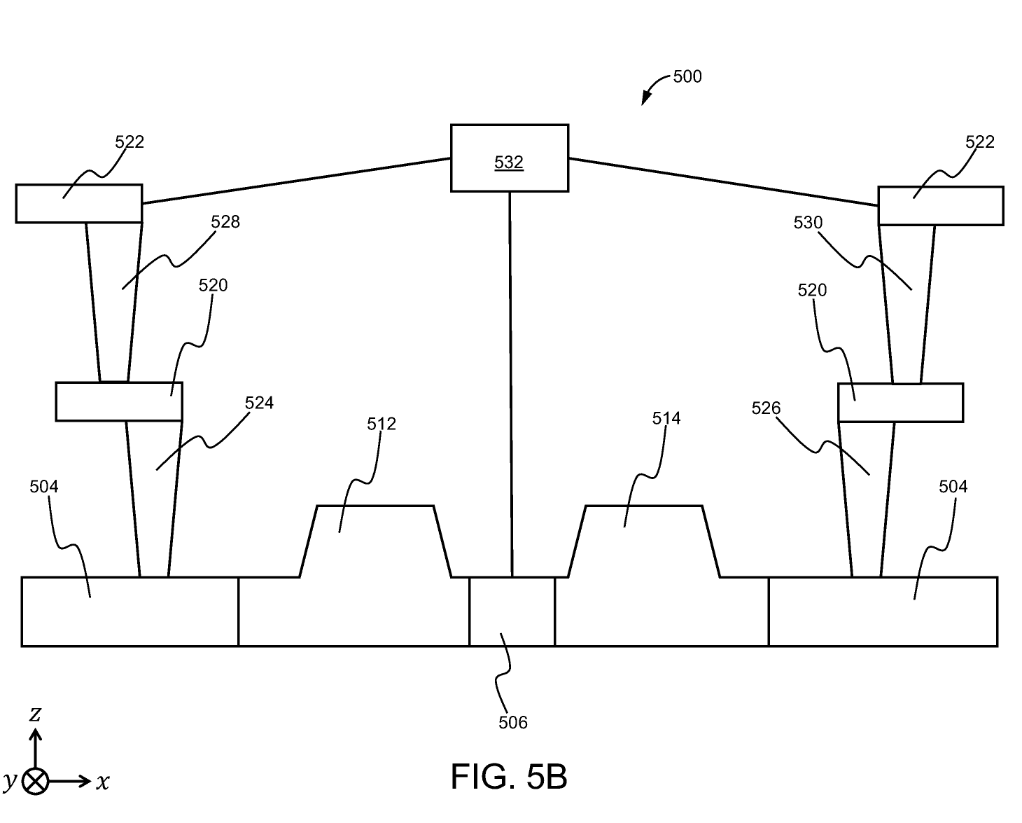

In some implementations, strain-inducing layers can be integrated into a device configured as a modulator. Some modulators can comprise a Mach-Zehnder configuration. FIG. 5A depicts a top view of an example device 500 and FIG. 5B depicts a cross-section view of the device 500 along a plane 502. The device 500 comprises a region 504 and a region 506, where each of the region 504 and the region 506 comprises a material with dopants mixed within. In some examples, the region 504 can comprise n-type dopants while the region 506 can comprise p-type dopants. The device 500 further comprises an optical waveguiding structure in optical communication with an input port 508 and an output port 510. Optical waves coupled into the input port 508 are split into a first waveguiding structure 512 and a second waveguiding structure 514. Each of the first waveguiding structure 512 and the second waveguiding structure 514 are formed from a region 516 and a region 518, respectively. Each of the region 516 and the region 518 are between the region 504 and the region 506 comprising dopants. In some examples, a strain-inducing structure can be positioned on one or more of the first waveguiding structure 512, the second waveguiding structure 514, or some combination thereof. The device 500 further comprises a conductive layer 520 and a conductive layer 522, i.e., metal layers. As shown in FIG. 5A, the conductive layer 520 comprises several portions that are configured to provide capacitive loading. Portions of the conductive layer 520 and the conductive layer 522 are interconnected a via 528 a via 530. The conductive layer 520 is in electrical communication with the region 504 and the region 506 by a via 524 and a via 526, respectively. The conductive layer 520, the conductive layer 522, the via 524, the via 526, the via 528, and the via 530 are configured to apply an electrical field between the region 504 and the region 506. In this example, a voltage source 532 is in electrical communication with the region 506 and the conductive layer 522.

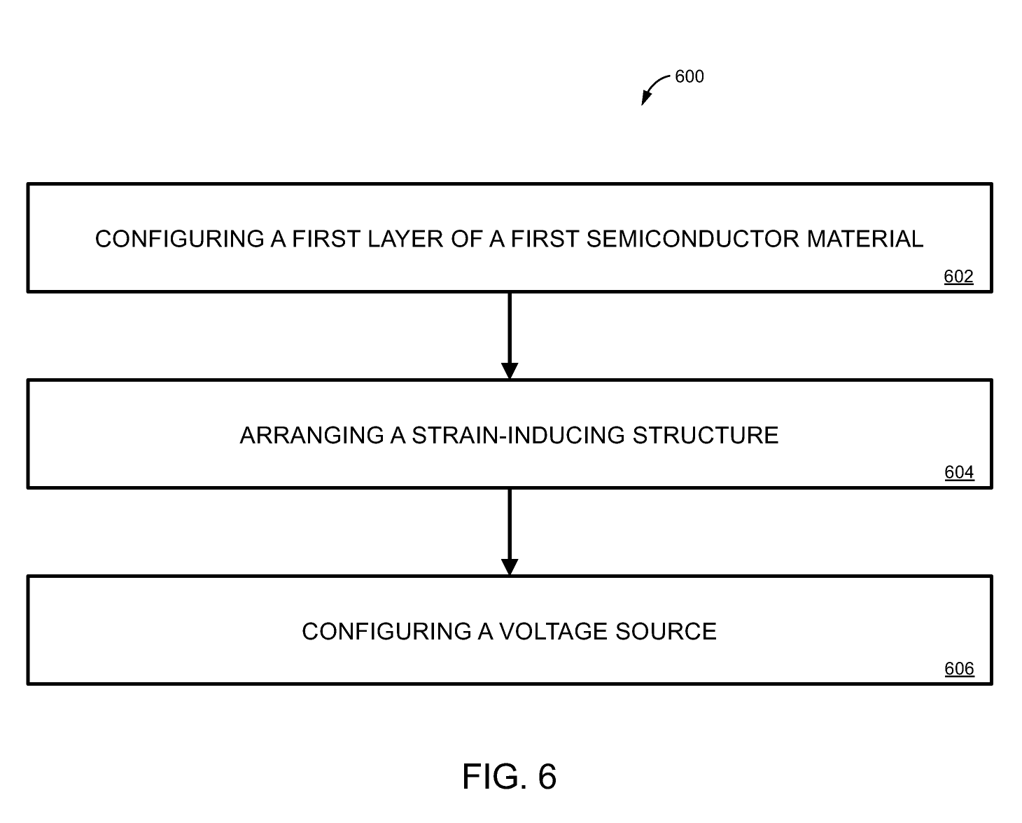

FIG. 6 depicts a flowchart of an example method 600 of configuring a device comprising a strain-inducing structure. The method 600 comprises configuring 602 a first layer of a first semiconductor material. In some implementations, the first layer can be substantially coplanar to a first plane. In some implementations, the first layer can comprise can comprise a first region having p-type dopants mixed within the first semiconductor material, a second region having n-type dopants mixed within the first semiconductor material, a third region wherein at least a portion of the third region is adjacent to a portion of the first region and a portion of the second region, and an optical waveguiding structure configured to guide an optical wave having a propagation direction that is substantially parallel to the first plane, wherein at least a portion of the optical waveguiding structure is formed in the portion of the third region that is adjacent to the portion of the first region and the portion of the second region. The method 600 further comprises arranging 604 a strain-inducing structure. In some implementations, the strain-inducing structure can be arranged in proximity to the optical waveguiding structure and can comprise one or more layers arranged along an axis that is substantially perpendicular to the first plane. In some implementations, the one or more layers can comprise a first strain-inducing layer comprising an alloy of silicon and germanium, where the first strain-inducing layer is configured to provide a strain to at least a portion of the first semiconductor material of the optical waveguiding structure. The method 600 further comprises configuring 606 a voltage source. In some implementations, the voltage source can be configured to apply a direct current electric field between the first region and the second region.

In some examples, electro-mechanical process simulations of a device can be used to predict a stress induced in a Si rib waveguide when a thin epitaxial SiGe layer is deposited on the upper interface. In some examples, a deposited layer of 20% Ge and 30% Ge on a relaxed waveguide of pure Si can induce a strain at the corners of the waveguide and then be distributed within the waveguide. In some implementations, a design parameter for a Kerr effect amplification can be associated with the waveguide width.

In some implementations, a device can be fabricated using several steps, i.e., a method. For instance, a silicon-on-insulator (SOI) wafer can be patterned to generate rib waveguides. The waveguide can be implanted with dopants, such as boron, phosphorus, and/or arsenic, to generate a PIN junction. A thin screening oxide layer can then be deposited on the whole circuit and that layer can be locally patterned (etched away) on the rib waveguide section. Selective epitaxial growth (SEG) of SiGe can then be processed so that a 5 nm ~ 10 nm thick layer is grown on the waveguide within the oxide window.

Some Si phase shifters can be operated by applying a high DC reverse bias on the transmission line of a PIN junction. An electric field generated by the bias can distort the crystal structure and can modify properties of the crystal. For instance, Kerr properties of the crystal can be modified by an electric field. An electrical RF signal can then be applied on the transmission line and modulate around that equilibrium position.

In some implementations, various aspects of the underlying Si geometry and device orientation on the die, i.e., Si crystal orientation, can be varied to obtain an optimal configuration. For example, an orientation of the DC electric field relative to a crystal structure of the semiconductor material in the device can be selected to provide an increased electrooptic effect in a region between p-type and n-type doped regions. In some implementations, electrodes by which the DC electric field is applied can be oriented on a surface of the semiconductor material such that a portion of the electric field in the region has a predetermined angle relative to a crystallographic axis of the semiconductor material. The increased electrooptic effect can be, for example, increased relative to an electrooptic effect resulting from a different orientation of the DC electric field relative to the crystal structure.

Some systems configured to manipulate optical waves can comprise semiconductor materials such as silicon or III/V compounds. Some examples of III/V compounds comprise elements from group III of the periodic table, such as boron, aluminum, gallium, or indium. Some examples of III/V compounds comprise elements from group V of the periodic table, such as nitrogen, phosphorous, arsenic, or antimony. Some devices can comprise semiconductor materials that are doped with p-type or n-type dopants. By way of example, p-type dopants can comprise elements such as tin, germanium, silicon, tellurium, and sulfur. By way of example, n-type dopants can comprise elements such as zinc, cadmium, beryllium, and magnesium.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
a first layer of a first semiconductor material, wherein the first layer is substantially coplanar to a first plane, the first layer comprising
a first region having p-type dopants mixed within the first semiconductor material,
a second region having n-type dopants mixed within the first semiconductor material,
a third region wherein at least a portion of the third region is adjacent to a portion of the first region and a portion of the second region, and
an optical waveguiding structure configured to guide an optical wave having a propagation direction that is substantially parallel to the first plane, wherein at least a portion of the optical waveguiding structure is formed in the portion of the third region that is adjacent to the portion of the first region and the portion of the second region;
a strain-inducing structure comprising one or more layers arranged along an axis that is substantially perpendicular to the first plane, the one or more layers comprising
a first strain-inducing layer comprising an alloy of silicon and germanium, where the first strain-inducing layer is configured to provide a strain to at least a portion of the first semiconductor material of the optical waveguiding structure; and
a voltage source configured to apply a direct current electric field between the first region and the second region.

2. The apparatus of claim 1, wherein the first strain-inducing layer is adjacent to a portion of the third region that contains the optical waveguiding structure.

3. The apparatus of claim 1, wherein the first semiconductor material comprises silicon.

4. The apparatus of claim 1, wherein the first strain-inducing layer conducts at least a portion of the direct current electric field.

5. The apparatus of claim 1, wherein the one or more layers of the strain-inducing structure further comprise a second strain-inducing layer formed in proximity to the first strain-inducing layer, where the second strain-inducing layer is configured to provide a strain to at least a portion of the first semiconductor material of the optical waveguiding structure.

6. The apparatus of claim 5, wherein the second strain-inducing layer is formed on at least a portion of the first strain-inducing layer.

7. The apparatus of claim 6, wherein the second strain-inducing layer comprises silicon nitride.

8. The apparatus of claim 5, wherein the one or more layers of the strain-inducing structure further comprise at least one layer separating the first strain-inducing layer from the second strain-inducing layer.

9. The apparatus of claim 8, wherein the second strain-inducing layer comprises a first portion of a metal layer and a second portion of a metal layer.

10. The apparatus of claim 8, wherein a spacing layer is formed on at least a portion of the first strain-inducing layer and the second strain-inducing layer is formed on at least a portion of the spacing layer.

11. The apparatus of claim 10, wherein the second strain-inducing layer comprises silicon nitride and the spacing layer comprises silicon dioxide.

12. The apparatus of claim 1, wherein the first strain-inducing layer is configured to provide a strain to the at least a portion of the first semiconductor material that shifts a nonlinear optical property associated with the at least a portion of the first semiconductor material.

13. The apparatus of claim 12, wherein the nonlinear optical property is a direct current Kerr effect.

14. The apparatus of claim 1, wherein the first strain-inducing layer has a first width and a second width along respective axes that are substantially parallel to the first plane and substantially perpendicular to the propagation direction, the first width being closer to an end of the optical waveguiding structure than the second width and the first width being smaller than the second width.

15. The apparatus of claim 1, wherein the optical waveguiding structure comprises a rib waveguide and the first strain-inducing layer is formed over the rib waveguide.

16. The apparatus of claim 1, wherein an orientation of the direct current electric field relative to a crystal structure of the first semiconductor material is selected to provide an increased electro-optic effect in the third region.

17. The apparatus of claim 1, wherein the strain provided by the first strain-inducing layer is associated with a difference between a lattice parameter of the alloy of silicon and germanium of the first strain-inducing layer and a lattice parameter of the first semiconductor material.

18. The apparatus of claim 1, wherein a thickness of the first strain-inducing layer is configured to confine an optical power of an optical wave to the optical waveguiding structure.

19. The apparatus of claim 18, wherein the thickness of the first strain-inducing layer is configured to confine at least 80% of an optical power of an optical wave in the optical waveguiding structure.

20. A method comprising:
configuring a first layer of a first semiconductor material, wherein the first layer is substantially coplanar to a first plane, the first layer comprising
a first region having p-type dopants mixed within the first semiconductor material,
a second region having n-type dopants mixed within the first semiconductor material,
a third region wherein at least a portion of the third region is adjacent to a portion of the first region and a portion of the second region, and
an optical waveguiding structure configured to guide an optical wave having a propagation direction that is substantially parallel to the first plane, wherein at least a portion of the optical waveguiding structure is formed in the portion of the third region that is adjacent to the portion of the first region and the portion of the second region;
arranging a strain-inducing structure in proximity to the optical waveguiding structure, the strain-inducing structure comprising one or more layers arranged along an axis that is substantially perpendicular to the first plane, where the one or more layers comprise
a first strain-inducing layer comprising an alloy of silicon and germanium, where the first strain-inducing layer is configured to provide a strain to at least a portion of the first semiconductor material of the optical waveguiding structure; and
configuring a voltage source to apply a direct current electric field between the first region and the second region.
